(19) United States
(12) Patent Application Publication
(10) Pub. No.: US 2026/0336322 A1
(43) Pub. Date: Oct. 29, 2026

(54) ROTARY FEEDING CONTAINER

(71) Applicant: MITSUBISHI PENCIL COMPANY, LIMITED, Tokyo (JP)

(72) Inventor: Tomotaka UEMURA, Fujioka-shi, Gunma (JP)

(21) Appl. No.: 19/490,368

(22) PCT Filed: Jun. 28, 2024
(86) PCT No.: PCT/JP2024/023484

§ 371 Date: Dec. 5, 2025

(30) Foreign Application Priority Data
Jun. 30, 2023 (JP) 2023-108540

(51) Int. Cl. B43K 21/08; A45D 40/04

(52) U.S. Cl. CPC B43K 21/08; A45D 40/04

(57) ABSTRACT

To provide a rotary feeding container capable of preventing breakage of a solid core accommodated within a barrel due to an impact applied to the barrel. The rotary feeding container is configured to include a screw rod that advances or retracts within a barrel by relative rotation between a front barrel and a rear barrel, and a solid core that moves in the axial direction within the front barrel in response to the advancing or retracting movement of the screw rod. A usable state of the solid core, in which the solid core is projected from the front barrel as the screw rod advances, and a retracted state, in which the solid core is retracted together with the holder into the front barrel as the screw rod retracts, can be selected.

### RELATED APPLICATIONS

The present application is National Phase of International Application No. PCT/JP2024/023484 filed Jun. 28, 2024, and claims priority from Japanese Application No. 2023-108540, filed Jun. 30, 2023.

### TECHNICAL FIELD

This invention relates to a rotary feeding container for stick-shaped cosmetic containers, writing instruments, and coating tools, which is used to advance stick-shaped components, such as stick-shaped cosmetics, stick-shaped writing materials, and stick-shaped coating materials from the container.

### BACKGROUND ART

Various cosmetic tools have been proposed in which, for example, a stick-shaped cosmetic is accommodated in a rotary feeding container, and a required amount of the stick-shaped cosmetic is fed from the front end portion thereof for use.

Among these, in the case of solid-core eyeliners for applying cosmetics, such as to the eyebrows, it has been proposed that the cross-sectional shape of the solid core, taken in a direction perpendicular to the axial direction, is elliptical or oval.

According to this structure, by changing the orientation of the solid core, the thickness of the cosmetic line applied at one time can be selected according to preference.

Rotary feeding containers accommodating such solid-core eyeliners with an elliptical or oval cross-sectional shape are disclosed in Patent Literature 1 and Patent Literature 2.

However, in the rotary feeding containers disclosed in Patent Literature 1 and Patent Literature 2, the solid core is configured to be advanced in only one direction. Accordingly, the solid core fed by the feeding operation cannot be returned into the barrel.

The present applicant has proposed a rotary feeding container in which a fed solid core can be returned to the inside of the barrel, which is disclosed in Patent Literature 3.

According to the rotary feeding container disclosed in Patent Literature 3, a screw rod that can move forward or backward by relative rotation of a rear barrel with respect to a front barrel is provided. Accordingly, the solid core is pushed out of the front barrel by the forward movement of the screw rod.

The backward movement of the screw rod causes the front end portion of the screw rod to pull the holder covering the outside of the solid core, thereby retracting the solid core together with the holder into the front barrel.

### CITATION LIST

### Patent Literature

[PTL 1] Japanese Unexamined Patent Application Publication No. 2016-220916

[PTL 2] Japanese Unexamined Patent Application Publication No. 2016-220917

[PTL 3] Japanese Unexamined Patent Application Publication No. 2021-90729

### SUMMARY OF INVENTION

### Technical Problem

The solid cores accommodated in this type of rotary feeding container often contain volatile components, and even in the aforementioned solid-core eyeliner, there is a problem that the solid core hardens due to volatilization of solvents and the like, resulting in functional deterioration.

Therefore, covering the outer circumference of the solid core accommodated in the aforementioned rotary feeding container with a tubular holder, as described in Patent Literature 3, is an effective countermeasure to suppress volatilization from the solid core.

However, when returning the fed solid core into the front barrel, the solid core, in a state where a predetermined length of the solid core protrudes from the front end portion of the tubular holder, is retracted into the front barrel together with the holder. Accordingly, the tip portion of the solid core protruding from the holder remains in an unsupported and floating state inside the front barrel, and when an impact, such as dropping, is applied to the barrel in this state, the problem that the protruding tip portion of the solid core is broken by receiving the impact occurs.

In view of such circumstances, the present invention has been made with the main object of providing a rotary feeding container capable of effectively preventing breakage of a solid core accommodated in the barrel due to impact applied to the barrel.

### Solution to Problem

The rotary feeding container according to the present invention, which has been made to solve the above-mentioned problems, is a rotary feeding container comprises: a barrel formed of a front barrel and a rear barrel configured to be relatively rotatable; a screw rod disposed inside the rear portion of the barrel and performing a forward or backward movement in the barrel by relative rotation of the front barrel and the rear barrel; and a stick-shaped member (solid core) disposed inside the front portion of the barrel and configured to move axial direction within the front barrel in response to the forward or backward movement of the screw rod, wherein the stick-shaped member is accommodated in a holder covering the outer circumference of the stick-shaped member, and a holder guide including a plurality of projections extending forward in the axial direction is provided at the tip end portion of the holder, and each is arranged along the circumferential direction, and a plurality of guide grooves extending axially is formed along the inner circumferential surface of the front shaft, into which each projection of the holder guide enters, allowing each projection to slide axially, and the front end of the stick-shaped member protruding from the holder is supported by the projections provided on the holder guide, during the both states in which the stick-shaped member protrudes from the front barrel in accompaniment with the forward movement of the screw rod and the stick-shaped member retracts and is stored together with the holder in the front barrel in accompaniment with the backward movement of the screw rod.

In this case, in a preferred embodiment, the rear barrel is rotatably attached to a middle barrel mounted on the front barrel, whereby the front barrel and the rear barrel are configured to be rotatable relative to each other. A female thread formed in the middle barrel is screwed with a male thread formed on the screw rod, and the screw rod is provided with a brim that is axially movable within the rear barrel and rotates the screw rod in the same direction in response to the rotation of the rear barrel.

Furthermore, it is preferable that a rib protruding toward the axis is formed along the axial direction inside the rear barrel, and the brim formed on the screw rod is movable in the axial direction along the rib, and a part of the brim comes into contact with the rib by the rotation of the rear barrel, whereby the screw rod is configured to be rotated in the same direction in accompaniment with the rotation of the rear barrel.

Furthermore, a large-diameter portion provided with a shaft hole is formed at a front end portion of the screw rod via a shaft body formed in a linear shape, and the large-diameter portion is configured such that the stick-shaped member is projected from the front barrel by advancement of the screw rod and a pulling operation is performed to retract the holder together with the stick-shaped member, in contact with the inside of the holder, by retraction of the screw rod.

### Advantageous Effect

According to the rotary feeding container of the present invention, the solid core as a stick-shaped member is accommodated within the holder and arranged so as to be projectable from and retractable into the front barrel in accompaniment with the forward and backward movement of the screw rod.

Since the front end portion of the holder is provided with a holder guide having a plurality of projections extending axially forward and arranged along the circumferential direction, the front end portion of the stick-shaped member protruding from the holder is supported by the respective projections provided on the holder guide when the stick-shaped member is retracted together with the holder and accommodated within the front barrel. According to this, it is possible to provide a rotary feeding container capable of effectively preventing breakage of the solid core as a stick-shaped member accommodated within the barrel even when subjected to an impact, for example, due to being dropped.

It is to be noted that other functions and advantages of the rotary feeding container according to the present invention will be described as appropriate in the section “Detailed Description of the Invention” set forth hereinafter.

### BRIEF DESCRIPTION OF DRAWING

FIG. 1 is a perspective view of a rotary feeding container according to a first embodiment of the present invention, shown with a cap removed.

FIGS. 2A to 2D show the rotary feeding container according to the first embodiment with the cap removed, wherein FIG. 2A is an external view, and FIG. 2B is a cross-sectional view taken along the axial direction.

FIGS. 2C and 2D show the rotary feeding container in a state obtained by rotating the container of FIGS. 2A and 2B about its axis by 90 degrees, wherein FIG. 2C is an external view, and FIG. 2D is a cross-sectional view taken along the axial direction.

FIG. 3 is an enlarged perspective view of a vicinity of a front end portion of the rotary feeding container, with a part of the front barrel according to the first embodiment cut away.

FIGS. 4A and 4B show the single-article configuration of the front barrel according to the first embodiment, wherein FIG. 4A is a perspective view taken from the tip end side, and FIG. 4B is a perspective view taken from the rear end side.

FIGS. 4C to 4H show the single-article configuration of the front barrel according to the first embodiment, wherein FIG. 4C is a top view, FIG. 4D is a longitudinal sectional view taken along the axial direction in FIG. 4C, FIG. 4E is a front view, FIG. 4F is a longitudinal sectional view taken along the axial direction in FIG. 4E, FIG. 4G is a left side view, and FIG. 4H is a right side view.

FIGS. 5A to 5D show the single-article configuration of a holder according to the first embodiment, wherein FIG. 5A is a top view, FIG. 5B is a longitudinal sectional view taken along the axial direction in FIG. 5A, FIG. 5C is a front view, and FIG. 5D is a longitudinal sectional view taken along the axial direction in FIG. 5C.

FIGS. 5E to 5H show a state in which a holder guide is attached to a front end portion of the holder according to the first embodiment, wherein FIG. 5E is a top view, FIG. 5F is a longitudinal sectional view taken along the axial direction in FIG. 5E, FIG. 5G is a front view, and FIG. 5H is a longitudinal sectional view taken along the axial direction FIG. 5G.

FIGS. 6A and 6B show a state before the holder guide is attached to the holder according to the first embodiment, wherein FIG. 6A is a perspective view taken from the holder guide side, and FIG. 6B is a perspective view taken from the holder side.

FIGS. 6C and 6D show a state in which the holder guide is attached to the holder according to the first embodiment, wherein FIG. 6C is a perspective view taken from the holder guide side, and FIG. 6D is a perspective view taken from the holder side.

FIGS. 7A to 7H show the single-article configuration of the holder guide according to the first embodiment, wherein FIG. 7A is a perspective view taken from the tip end side, FIG. 7B is a perspective view taken from the rear end side, FIG. 7C is a top view, FIG. 7D is a longitudinal sectional view taken along the axial direction in FIG. 7C, FIG. 7E is a front view, FIG. 7F is a longitudinal sectional view taken along the axial direction in FIG. 7E, FIG. 7G is a left side view, and FIG. 7H is a right side view.

FIGS. 8A to 8D show the single-article configuration of a middle barrel according to the first embodiment, wherein FIG. 8A is a perspective view taken from the tip end side, FIG. 8B is a perspective view taken from the rear end side, FIG. 8C is a top view, and FIG. 8D is a cross-sectional view taken along the axial direction.

FIGS. 9A to 9D show the single-article configuration of a screw rod according to the first embodiment, wherein FIG. 9A is a perspective view taken from the tip end side, FIG. 9B is a front view, FIG. 9C is a top view, and FIG. 9D is a cross-sectional view taken along the axial direction.

FIGS. 10A to 10D show the single-article configuration of a screw body according to the first embodiment, wherein FIG. 10A is a perspective view taken from the tip end side, FIG. 10B is a perspective view taken from the rear end side, FIG. 10C is a front view, and FIG. 10D is a cross-sectional view taken along the axial direction.

FIGS. 11A to 11B show the single-article configuration of a rear barrel according to the first embodiment, wherein FIG. 11A is a cross-sectional view taken along the axial direction, and FIG. 11B is a cross-sectional view taken in the direction of the arrow along line 11B-11B in FIG. 11A.

FIGS. 12A and 12B show the rotary feeding container according to the second embodiment with the cap removed, wherein FIG. 12A is an external view, and FIG. 12B is a cross-sectional view taken along the axial direction.

FIGS. 12C and 12D show the rotary feeding container in a state obtained by rotating the container of FIG. 12A about its axis by 90 degrees, wherein FIG. 12C is an external view, and FIG. 12D is a cross-sectional view taken along the axial direction.

FIGS. 13A to 13F show the single-article configuration of the front barrel according to the second embodiment, wherein FIG. 13A is a top view, FIG. 13B is a longitudinal sectional view taken along the axial direction in FIG. 13A, FIG. 13C is a front view, FIG. 13D is a longitudinal sectional view taken along the axial direction in FIG. 13C, FIG. 13E is a left side view, and FIG. 13F is a right side view.

FIGS. 14A to 14D show the single-article configuration of the middle barrel according to the second embodiment, wherein FIG. 14A is a perspective view taken from the tip end side, FIG. 14B is a perspective view taken from the rear end side, FIG. 14C is a top view, and FIG. 14D is a cross-sectional view taken along the axial direction.

FIGS. 15A to 15E show the single-article configuration of the screw rod according to the second embodiment, wherein FIG. 15A is a perspective view taken from the tip end side, FIG. 15B is a front view, FIG. 15C is a top view, FIG. 15D is a cross-sectional view taken along the axial direction, and FIG. 15E is a right side view.

FIGS. 16A to 16D show the single-article configuration of the rear barrel according to the second embodiment, wherein FIG. 16A is a front view, FIG. 16B is a cross-sectional view taken along the axial direction, FIG. 16C is a left side view, and FIG. 16D is a cross-sectional view taken in the direction of the arrow along line 16D-16D in FIG. 16B.

### DESCRIPTION OF EMBODIMENTS

The rotary feeding container according to the present invention will be described below based on an embodiment of a cosmetic tool in which a solid-core eyeliner is used as the stick-shaped member housed within the container.

It should be noted that, in the drawings shown below, identical reference numerals denote identical parts; however, in some of the drawings, reference numerals are attached only to representative portions due to space limitations on the drawing sheet, and the details thereof will be explained by referring to the reference numerals used in the drawings showing the single-article configuration.

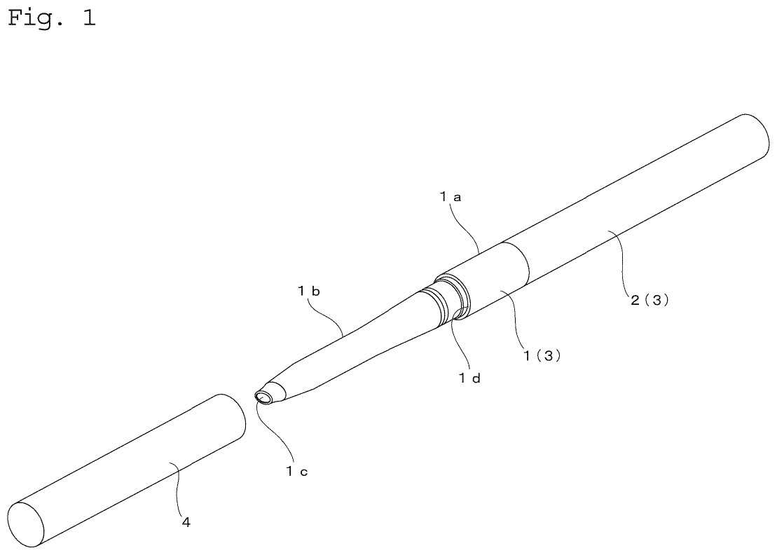

First, a first embodiment of the rotary feeding container according to the present invention will be described with reference to FIG. 1 to FIG. 11B.

As shown in FIG. 1, the rotary dispensing container of the first embodiment of the present invention configures a shaft cylinder 3 formed by attaching a rear barrel 2 formed in a bottomed cylinder relative to the front shaft 1, capable of relative rotation.

The front barrel 1 is provided with a reduced-diameter portion 1b that extends forward next to a cylindrical portion la, and an opening 1c is formed at the front end portion of the reduced-diameter portion 1b, and a solid core 5, serving as the stick-shaped member described later, is configured to be advanced and retracted through this opening 1c.

A cap 4 having a bottomed cylindrical shape is mounted in the axial direction such that its open end abuts a cap-mounting step portion 1d formed on the front barrel 1, thereby covering the reduced-diameter portion 1b of the front barrel 1. As a result, the rotary feeding container with the cap 4 attached is configured such that its outer appearance forms an elongated cylindrical body having a substantially uniform diameter in the longitudinal direction.

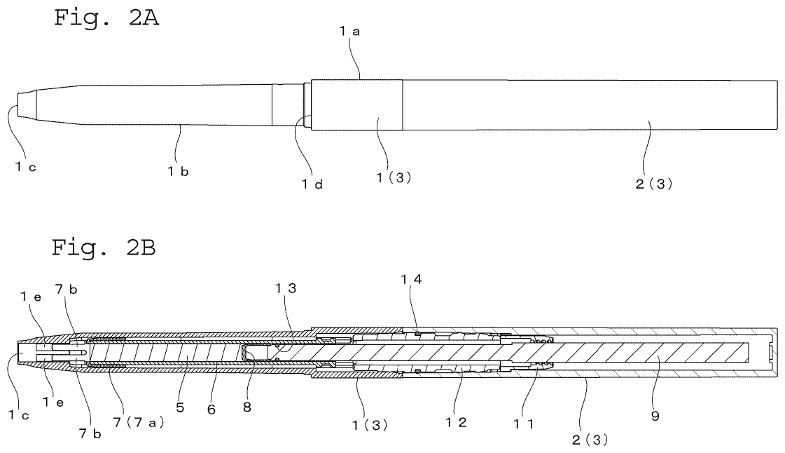

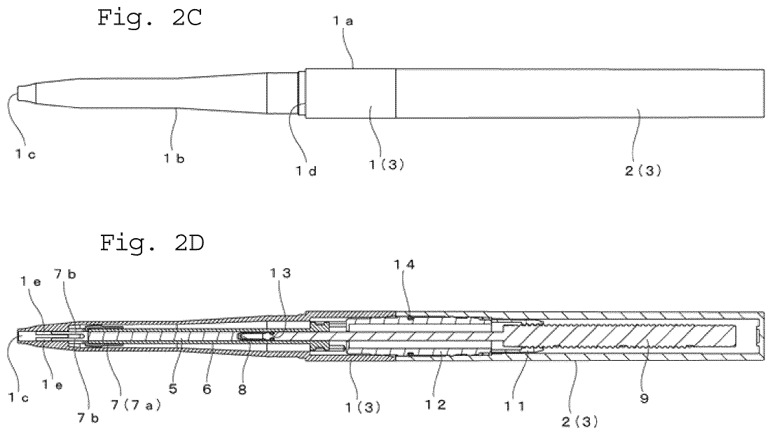

FIGS. 2A to 2D show an external view and a cross-sectional view, respectively, of the rotary feeding container with the cap 4 removed, and the solid core eyeliner 5 serving as the stick-shaped member (hereinafter sometimes simply referred to as the “solid core 5”) is accommodated within the front barrel 1. Note that the solid core 5 is housed within a holder 6 that surrounds its outer periphery, and a cylindrical base end portion 7a of a holder guide 7 mounted at the front end portion of the holder 6 is disposed in contact with the inner surface of the front barrel 1.

In addition, a piston 8 is housed at the rear end portion of the holder 6 so as to be in contact with the inner surface of the holder 6 and movable in the axial direction of the holder 6. The piston 8 is pushed forward by a screw rod 9, advancing the solid core 5 within the holder 6 through the front-end opening 1c of the front barrel 1.

It should be noted that the piston 8 also serves as a sealing member to prevent the rear portion side of the solid core 5 from being exposed to the atmosphere and causing solvent evaporation. This prevents the remaining part of the solid core 5 from hardening, thereby avoiding issues of performance degradation.

The aforementioned screw rod 9 is disposed at the rear portion of the aforementioned solid core 5 and the piston 8. The screw rod 9 operates to advance or retract within the barrel 3 due to the relative rotation of the rear barrel 2 with respect to the front barrel 1. The advancing and retracting operation of the screw rod 9 is actuated by a screw body 11 that is disposed within the rear barrel 2 and a middle barrel 12 that is press-fitted and mounted into the rear end portion of the front barrel 1. The advancing and retracting action of the screw rod 9 will be described in more detail when the single-article configurations of the screw body 11 and the middle barrel 12 are described later.

In this embodiment, the reduced-diameter portion 1b, the opening 1c, the solid core 5, the holder 6, the holder guide 7, the piston 8, and the front half portion of the screw rod 9 in the above-described front barrel 1 each have a cross-sectional shape perpendicular to the axial direction that is formed in an elliptical configuration.

A ring-shaped elastic member (O-ring) 13 is mounted along the outer periphery of the front end portion of the screw rod 9, and when the screw rod 9 moves forward, the O-ring 13 slidingly contacts the inner surface of the holder 6 and advances within the holder 6, while at the same time acting through the piston 8 at the front end portion of the screw rod 9 to push the solid core 5 forward out of the holder 6.

Besides, when the screw rod 9 moves backward, the O-ring 13, while being pressed against the inner surface of the holder 6, the motion causes the solid core 5 to retract together with the holder 6 within the front barrel 1.

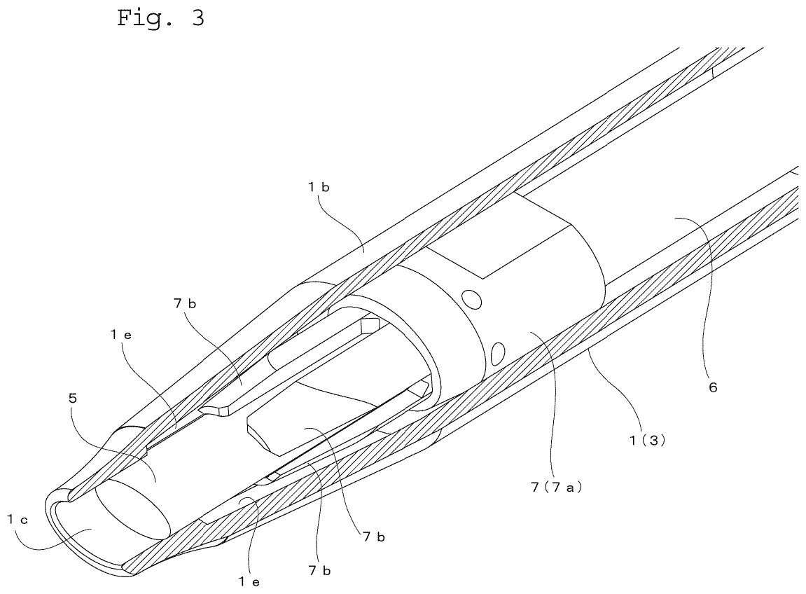

FIG. 3 shows a state in which a portion of the reduced-diameter portion 1b of the front barrel 1 of the rotary feeding container is cut away.

As described above, a holder guide 7 is mounted at the front end portion of the holder 6 that covers the outer periphery of the solid core 5, and the holder guide 7 is provided with a plurality of projections 7b (four in this example) extending in the axial forward direction from a cylindrical base end portion 7a, and these projections 7b are arranged along the circumferential direction of the base end portion 7a.

Meanwhile, on the inner peripheral surface of the reduced-diameter portion 1b of the front barrel 1, a plurality of guide grooves 1e (four in this example, corresponding in number to the projections 7b) that extend in the axial direction is formed along the inner circumferential surface on the tip end side of the front barrel 1 at intervals, and the projections 7b of the holder guide 7 can enter the grooves and are caused to slide in the axial direction.

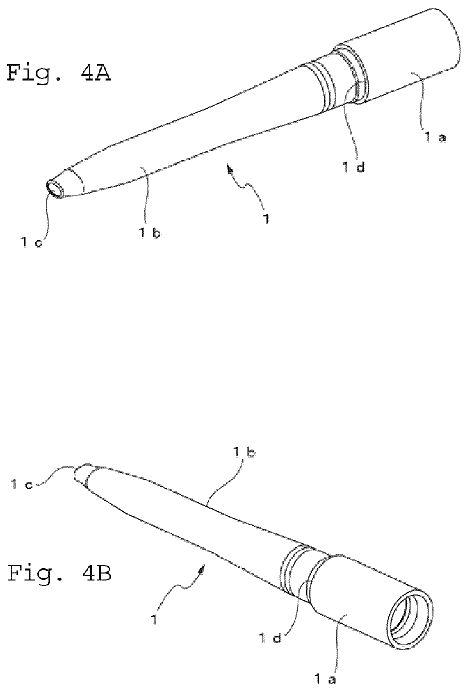

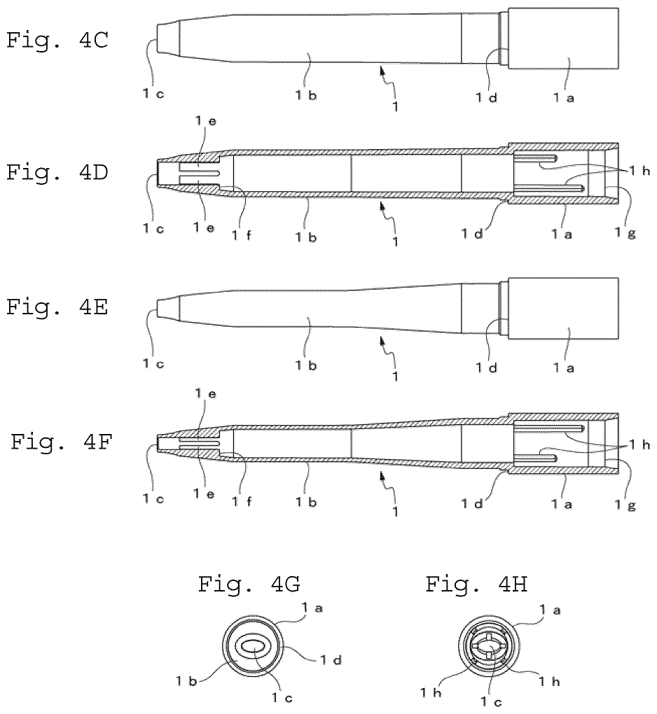

FIGS. 4A to 11B show single-article configurations, or assembled structures of two components, used in the rotary feeding container shown in FIGS. 1 to 3, and the configurations of the individual components will be described below with reference to FIGS. 4A to 11B.

FIGS. 4A to 4H show the single-article configuration of the front barrel 1, and as described above, the front barrel 1 is formed with the cylindrical portion 1a at the rear end portion thereof, and the reduced-diameter portion 1b having an elliptical cross-section perpendicular to the axis is formed forward of and next to the cylindrical portion 1a. The opening 1c is formed at the tip end portion of the reduced-diameter portion 1b to support the solid core 5 and enable it to advance and retract, and the cap-mounting step portion 1d is formed between the cylindrical portion 1a and the reduced-diameter portion 1b.

Furthermore, as shown in FIGS. 4C to 4H, a step portion If is formed to reduce the inner diameter from the inner surface of the reduced-diameter portion 1b toward the opening 1c. The base end portion 7a of the holder guide 7, which is mounted at the front end portion of the holder 6, engages with the step portion 1f, resultantly, the step portion If functions as a stopper that prevents the holder 6 from advancing. Accordingly, the step portion 1f will hereinafter be referred to as the stopper.

In addition, a plurality of guide grooves 1e are formed to receive and support the respective projections 7b of the aforementioned holder guide 7 from the stopper 1f toward the front end opening 1c; the grooves are movable in the axial direction together with the holder 6.

An annular projection 1g is formed on the inner surface of the rear end opening portion of the cylindrical portion 1a, and this projection serves as a fitting portion used when a middle barrel 12, described later, is mounted by press-fitting.

In addition, on the inner peripheral surface adjacent to the annular projection 1g of the cylindrical portion 1a, four long and short ribs 1h are formed at equal intervals along the axial direction. These long and short ribs 1h are used for circumferential positioning when the middle barrel 12 is press-fitted into the cylindrical portion 1a.

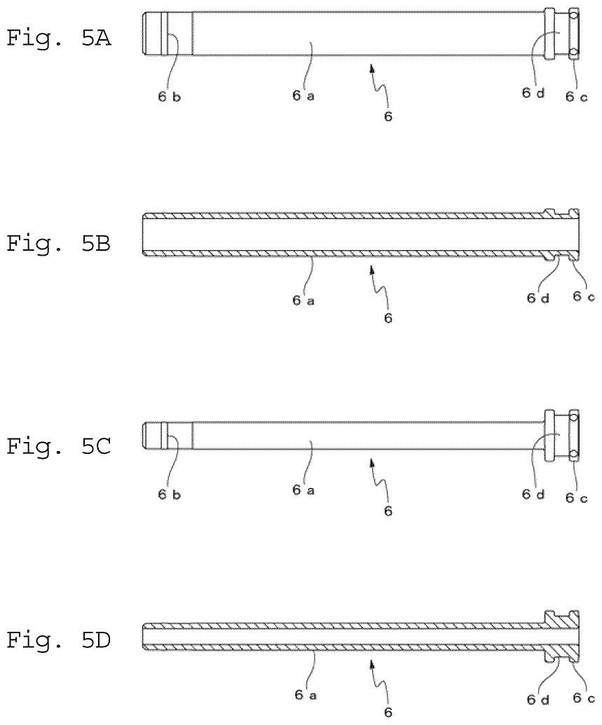

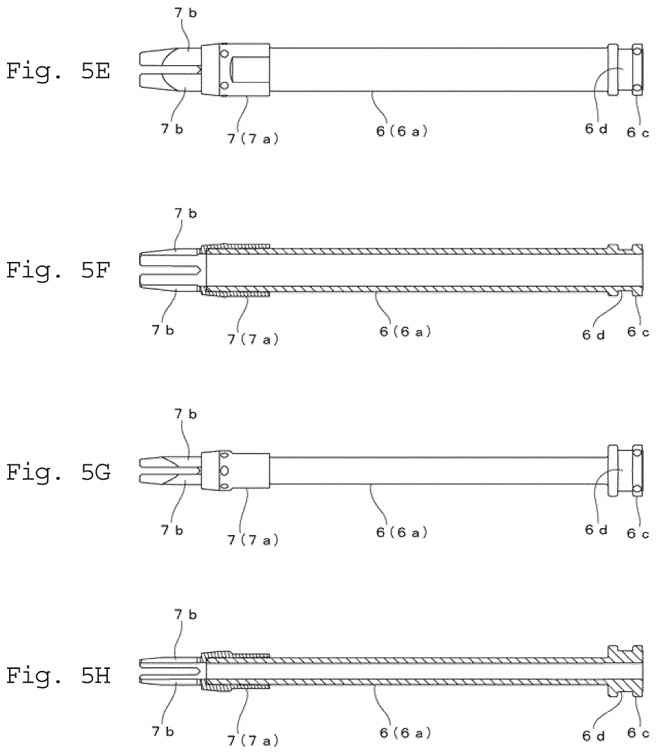

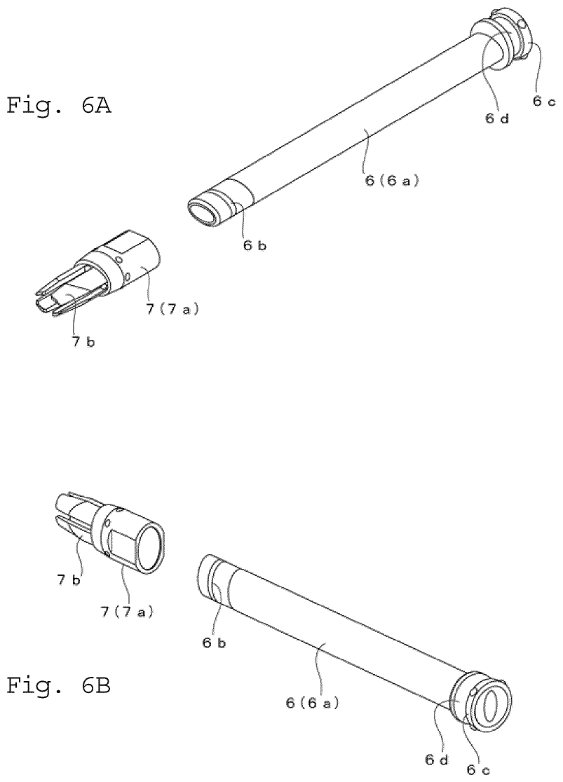

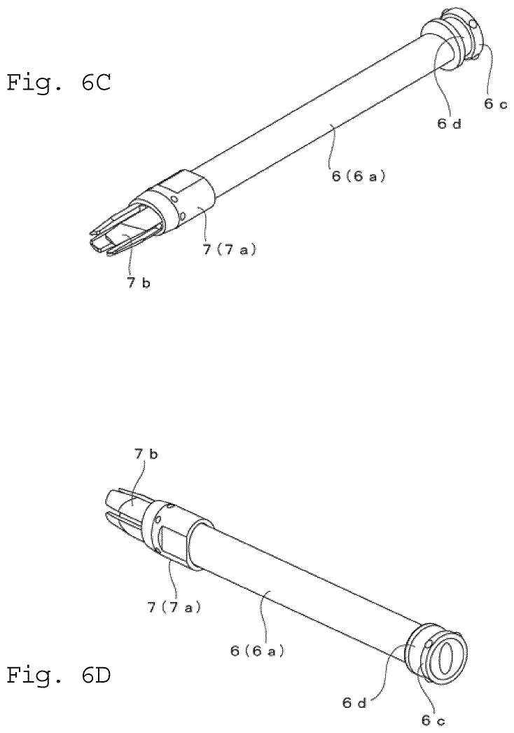

FIGS. 5A to 5D show the single-article configuration of the holder 6 accommodated within the front barrel 1, and FIGS. 5E to 5H show a state in which the holder guide 7 is mounted on the front end portion of the holder 6. In addition, FIGS. 6A to 6D show perspective views of the state before and after the holder guide 7 is mounted on the front end portion of the holder 6, respectively.

As previously described, the holder 6 formed along the axial direction has an elliptical cross-section perpendicular to the axis and a solid core accommodating portion 6a that can accommodate the rod-shaped solid core 5 therein.

An annular rib 6b is integrally formed, projecting on the outer periphery of the front end portion of the holder 6. The annular rib 6b is formed to achieve a predetermined fitting strength when the holder guide 7, described later, is mounted on the front end portion of the holder 6.

In addition, a short-length cylindrical portion 6c having a groove 6d formed along its circumference is provided at the rear end portion of the holder 6.

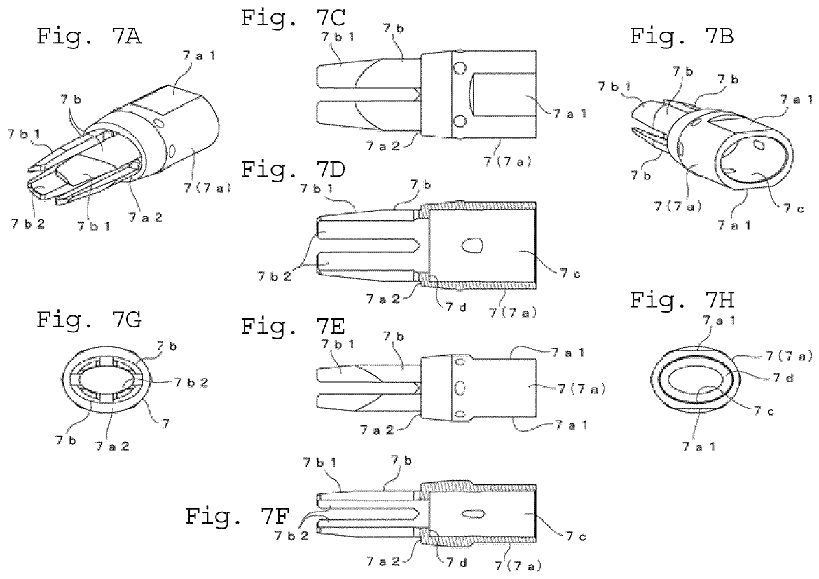

The single-article configuration of the holder guide 7, which is mounted on the front end portion of the holder 6, is shown in FIGS. 7A to 7H. As already described, the holder guide 7 is provided with four projections 7b extending forward in the axial direction from a cylindrical base end portion 7a, which are disposed along the circumferential direction of the base end portion 7a.

In addition, the base end portion 7a, formed into an elliptical shape, has flat surface portions 7a1 formed in parallel on the upper and lower sides along the major axis direction of the ellipse. An axial hole 7c is formed in the base end portion 7a, into which the front end portion of the holder 6 is inserted. The holder guide 7 is fitted and mounted on the front end portion of the holder 6 in a state where the front end portion of the holder 6 abuts an annular step portion 7d formed inside the axial hole 7c (see FIGS. 7D and 7F).

An annular surface 7a2, perpendicular to the axis, is formed at the front of the base end portion 7a, that is, at the root portion of the projections 7b. When accommodated within the front barrel 1, this annular surface 7a2, upon advancing together with the holder 6 under the pushing force exerted by the screw rod 9, comes into contact with the stopper 1f formed inside the front barrel 1 (see FIGS. 4D and 4F) and functions to prevent further advancement of the holder 6. As a result, the solid core 5 accommodated within the holder 6 is pushed and moved within the holder 6 by the screw rod 9 and the piston 8 and is thereby fed forward from the opening 1c of the front barrel 1.

Furthermore, the four projections 7b formed on the base end portion 7a are disposed along the elliptical shape of the base end portion 7a, and the outer surfaces on the tip end side of each projection 7b form tapered surfaces 7bl inclined in the axial direction.

In addition, the inner surfaces of the respective projections 7b are formed along the elliptical peripheral surface of the solid core 5 fed from the holder 6 and constitute holding surfaces 7b2 for the solid core 5. Accordingly, the solid core 5 projecting from the holder 6 is supported by the inner holding surfaces 7b2 of the respective projections 7b.

The solid core (5) loaded into the holder (6) contains the volatile components of the eyeliner. These include volatile silicones (e.g., cyclopentasiloxane, dimethicone, and trimethylsiloxysilicate), volatile hydrocarbons (e.g., isododecane and light isoparaffin), and film-forming resins that are soluble in these solvents.

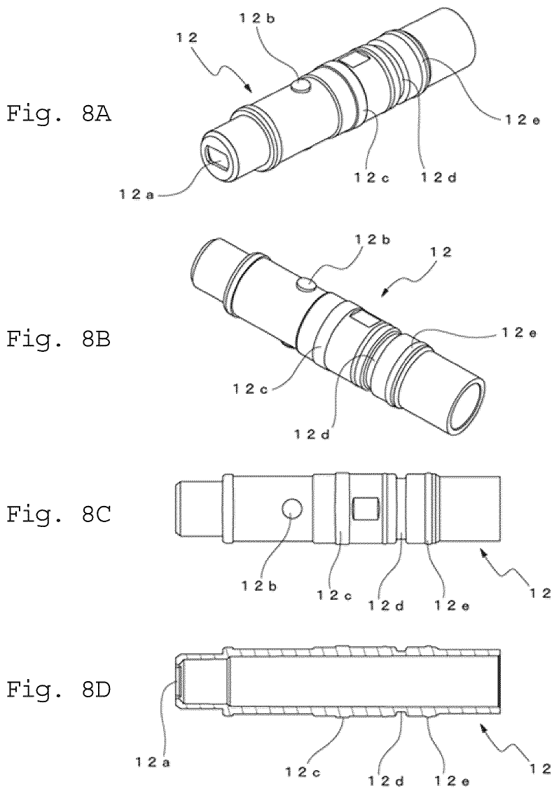

FIGS. 8A to 8D show a single-article configuration of the middle barrel 12, which is attached by press-fitting to the rear end portion of the aforementioned front barrel 1.

The middle barrel 12 is provided, at its front end portion, with a screw rod insertion hole 12a, and this screw rod insertion hole 12a is shaped into a similar elliptical or rectangular configuration so as to allow insertion of an elliptical shaft body 9a formed in a front half portion of a screw rod 9, which will be described later.

Furthermore, the middle barrel 12 is sequentially formed, from its front end portion toward its rear end portion, with a pair of circular projections 12b formed to extend outwardly on both lateral sides of the shaft, a first annular rib 12c projecting in the circumferential direction, an O-ring mounting groove 12d, and a second annular rib 12e projecting in the circumferential direction.

The pair of circular projections 12b are selectively inserted between four long and short ribs 1h formed inside the cylindrical portion 1a of the front barrel 1, and are thereby utilized for aligning the circumferential positions between the front barrel 1 and the middle barrel 12.

In addition, the first annular rib 12c engages with an annular projection 1g formed inside the cylindrical portion 1a of the front barrel 1, thereby functions to allow the middle barrel 12 to be press-fitted and fitted onto the rear end portion of the front barrel 1.

Furthermore, an O-ring 14 shown in FIGS. 2B and 2D is mounted in the O-ring mounting groove 12d, and the O-ring 14 is configured to be in sliding contact, in the circumferential direction of shaft rotation, with the inner peripheral surface of the rear barrel 2.

Still more, the annular rib 12e projecting in the circumferential direction near the rear end portion of the middle barrel 12 serves as a retaining member to prevent the rear barrel 2, which is mounted on the rear end portion of the middle barrel 12, from coming off.

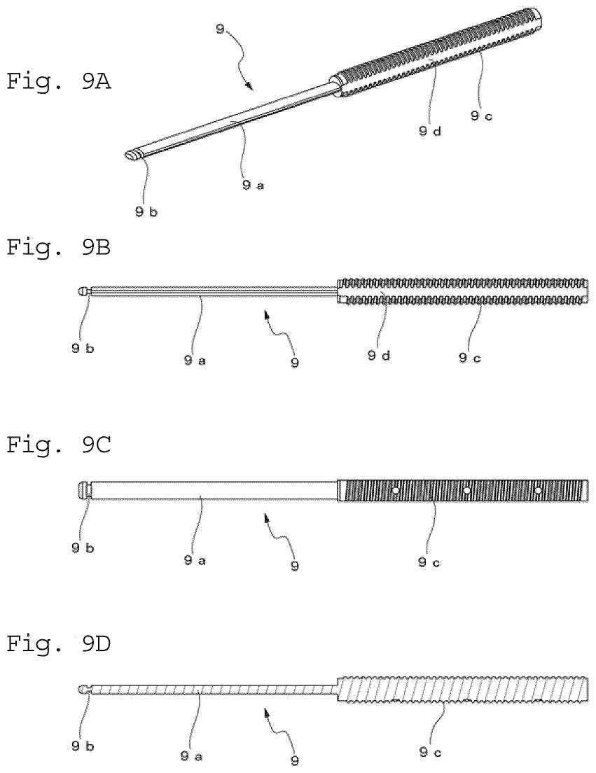

FIGS. 9A to 9D show a single-article configuration of a screw rod 9. This screw rod 9 has, in its front half portion, an elliptical shaft body 9a whose cross section perpendicular to the axis is formed into an elliptical shape, and an O-ring mounting groove 9b is formed at its front end portion. A ring-shaped elastic member (O-ring) 13, as shown in FIGS. 2B and 2D, is mounted in this mounting groove 9b.

In addition, the rear half portion of the screw rod 9 is formed with a substantially circular cross-section, and male threads 9c are formed along its upper and lower surfaces, and flat surface portions 9d extending in the longitudinal direction are formed along both side surfaces thereof.

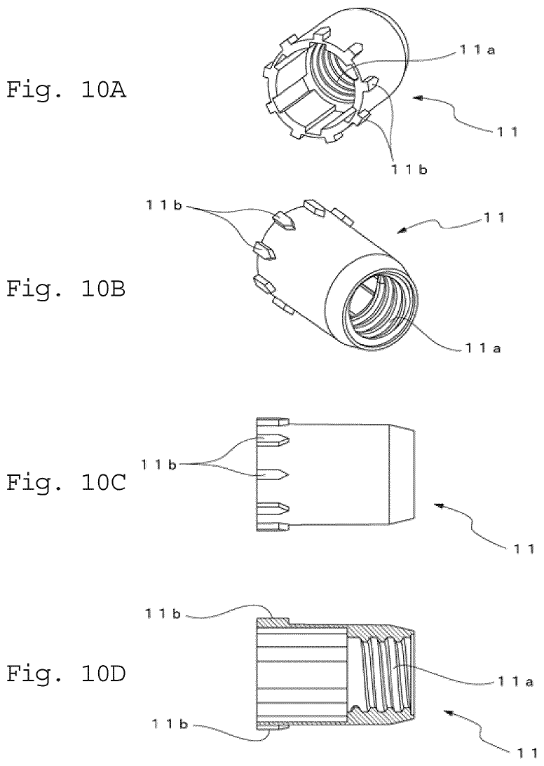

FIGS. 10A to 10D show the single-article configuration of a screw body 11, and the screw body 11 is formed into a tubular shape, and a female thread 11a is formed on the inner peripheral surface of its rear end portion. The female thread 11a is configured to be threadedly engaged with the male thread 9c of the screw rod 9 shown in FIGS. 9A to 9D.

In addition, a plurality of rotation-preventing ribs 11b is formed along the axial direction on the outer peripheral surface of the front end portion of the screw body 11, and these ribs 11b are formed substantially at equal intervals in the circumferential direction.

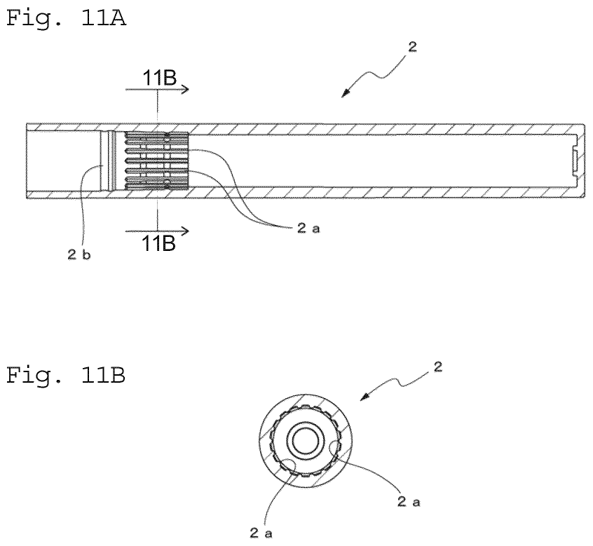

FIGS. 11A and 11B show the single-article configuration of the rear barrel 2, and the rear barrel 2 is formed into a cylindrical shape with its rear end portion closed. On the inner circumferential surface near the opening at the front end portion, a plurality of longitudinal ribs 2a is formed substantially at equal intervals along the inner circumference.

When the screw body 11 is inserted into the rear barrel 2 from the rear end portion of the screw body 11 where the female thread 11a is formed, the rotation-preventing ribs 11b of the screw body 11 engage with the plurality of longitudinal ribs 2a formed inside the rear barrel 2. As a result, the screw body 11 is held in place within the rear barrel 2, in a state where its rotation is prevented.

A circular rib 2b is formed so as to protrude from the inner circumferential surface at a position closer to the front-end opening than the position where the plurality of longitudinal ribs 2a is formed.

This circular rib 2b protruding from the inner circumferential surface axially rides over the annular rib 12e formed on the rear end portion of the middle barrel 12, thereby preventing the middle barrel 12 and the rear barrel 2 from coming loose and connecting them so that they can rotate relative to each other.

The front end portion of the middle barrel 12 is press-fit into the front barrel 1, resulting in the front barrel 1 and the rear barrel 2 being configured to rotate relative to each other via the middle barrel 12.

In the rotary feeding container according to the first embodiment described above, in order to advance the solid core 5, which serves as a stick-shaped member, from the front end opening 1c of the front barrel 1, the rear barrel 2 is rotated in a right-hand direction relative to the front barrel 1.

As a result, the screw body 11 within the rear barrel 2 also rotates in the same direction. Since the elliptical shaft body 9a at the front end portion of the screw rod 9, which is threadedly engaged with the screw body 11, is inserted into the screw rod insertion hole 12a of the middle barrel 12 and thereby prevented from rotating about the axis, the screw rod 9 advances in response to the right-hand rotation of the screw body 11.

Accordingly, through the piston 8 that is pushed forward by the screw rod 9, the solid core 5 advances together with the holder 6 and the holder guide 7.

On the other hand, as the solid core 5, the holder 6, and the holder guide 7 advance, the annular surface 7a2 formed on the holder guide 7 comes into abutment with the stopper 1f formed inside the front barrel 1, thereby preventing further forward movement. Consequently, the solid core 5 within the holder 6 advances through the holder 6 and the holder guide 7 via the piston 8 as the screw rod 9 moves forward, and the front end portion of the solid core 5 is fed out from the front-end opening 1c of the front barrel 1.

Accordingly, a user can apply makeup, such as drawing eyebrows, by using the solid core eyeliner extruded from the rotary feeding container.

After use of the solid core eyeliner, it is necessary to retract the solid core 5, which has been fed out from the front barrel 1, back into the interior of the front barrel 1, and in this retraction operation, the rear barrel 2 is rotated in a left-hand direction relative to the front barrel 1. As a result, the screw body 11 within the rear barrel 2 also rotates in the same direction, and the screw rod 9, whose axial rotation is prevented by the screw rod insertion hole 12a of the middle barrel 12, moves backward within the barrel 3 in response to the left-hand rotation of the screw body 11.

As the screw rod 9 retracts, the ring-shaped elastic member (O-ring) 13 mounted on the front end portion of the screw rod 9 engages and presses against the inner surface of the holder 6, thereby pulling the holder 6 backward. Accordingly, the solid core 5, whose front end has been fed out, retracts into the front barrel 1 together with the holder 6 and the holder guide 7, whereby the front end portion of the solid core 5 is returned into the front barrel 1.

FIG. 3 shows a state in which the front end portion of the solid core 5, which had been fed out from the front barrel 1, has been retracted back into the front barrel 1 by the above-described operation.

As shown in FIG. 3, the solid core 5, which projects from the front end portion of the holder 6 that has been retracted into the front barrel 1, is held in a supported state by a plurality (four) of projections 7b provided on the holder guide 7. Moreover, the inner surfaces of the respective projections 7b that support the solid core 5 constitute holding surfaces 7b2 [see FIGS. 7A, 7D and 7F] which conform to the elliptical peripheral surface of the solid core 5 delivered from the holder 6.

As a result, the solid core 5 projecting from the holder 6 can be supported without any gap by the inner holding surfaces 7b2 of the respective projections 7b.

Accordingly, it is possible to provide a rotary feeding container capable of effectively preventing problems such as cracking or breaking of the solid core 5 that projects from the holder 6, even when an impact is applied to the container (barrel 3), for example, if the cosmetic tool is accidentally dropped and so on.

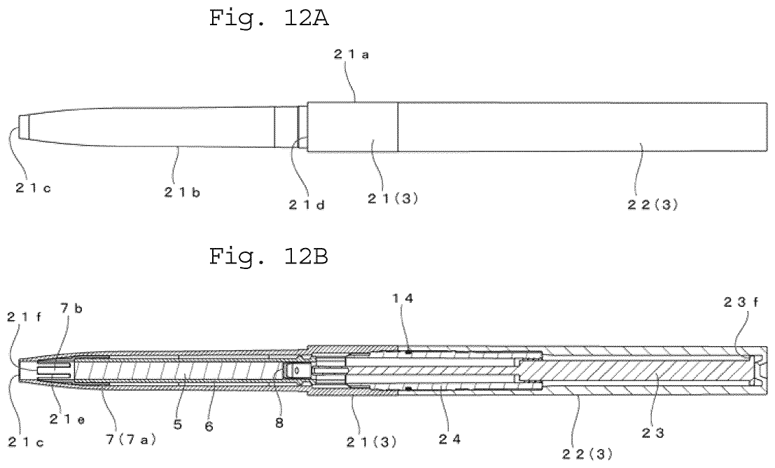

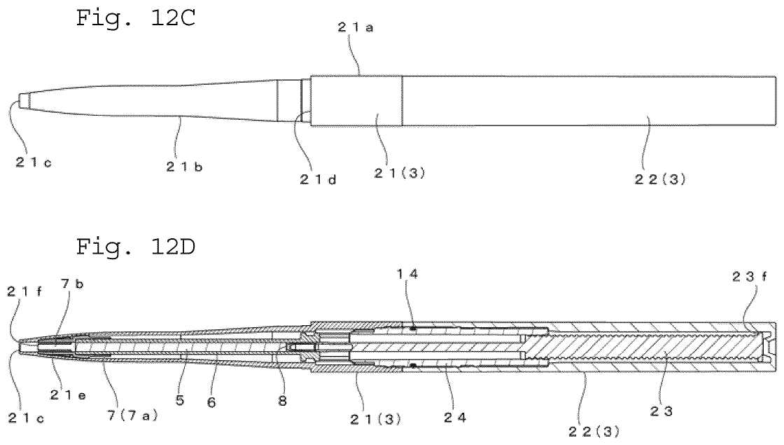

Next, a second embodiment of the rotary feeding container according to the present invention will be described with reference to FIGS. 12A to 16D.

In the rotary feeding container of the second embodiment, components other than the front barrel 1, the rear barrel 2, the screw rod 9, the screw body 11, and the middle barrel 12 used in the first embodiment are employed as the same common components in the second embodiment as well. Accordingly, in the following description, common components used in the first embodiment are designated by the same reference numerals, and their explanations will be omitted as appropriate; then the description will mainly focus on the configurations of new components used in the second embodiment.

In the second embodiment, components corresponding to the aforementioned front barrel 1, the rear barrel 2, the screw rod 9, the screw body 11, and the middle barrel 12 used in the first embodiment are respectively provided as a front barrel 21, a rear barrel 22, a screw rod 23, and a middle barrel 24 equipped with a screw body, as described below.

FIGS. 12A to 12D show the external configuration and an axial cross-sectional view of the rotary feeding container according to the second embodiment, excluding the cap. In the rotary feeding container of this second embodiment as well, similarly to the first embodiment, the rear barrel 22 is mounted on the front barrel 21 to be rotatable relative thereto, thereby forming the barrel 3.

Furthermore, the open end of the cap 4, formed into a bottomed cylindrical shape as shown in FIG. 1, abuts the cap-mounting step portion 21d formed on the front barrel 21 and is mounted in the axial direction so as to cover the small-diameter portion 21b of the front barrel 21. As a result, the external appearance of the rotary feeding container with the cap 4 attached is configured to form an elongated cylindrical body having a substantially uniform diameter in the longitudinal direction.

In addition, the basic operation in which the solid core 5, serving as a stick-shaped member, is fed out from the front-end opening 21c of the front barrel 21 by rotating the rear barrel 22 clockwise relative to the front barrel 21, and the solid core 5 is retracted back into the front barrel 21 by rotating the rear barrel 22 counterclockwise, is similar to that of the first embodiment.

Furthermore, it is also the same as the first embodiment that the holder 6, in which the solid core 5 is accommodated, has the configuration that the plurality of projections 7b that support the solid core 5 projecting from the holder 6 are provided, and the solid core 5 is supported without any gap by the inner holding surfaces 7b2 of the respective projections 7b.

Meanwhile, the rotary feeding container of the second embodiment has distinctive features that differ from those of the rotary feeding container of the first embodiment; particularly, in the mechanism for axial movement of the screw rod 23 accompanying the relative rotation of the rear barrel 22 with respect to the front barrel 21, and in the coupling mechanism between the screw rod 23 and the holder 6.

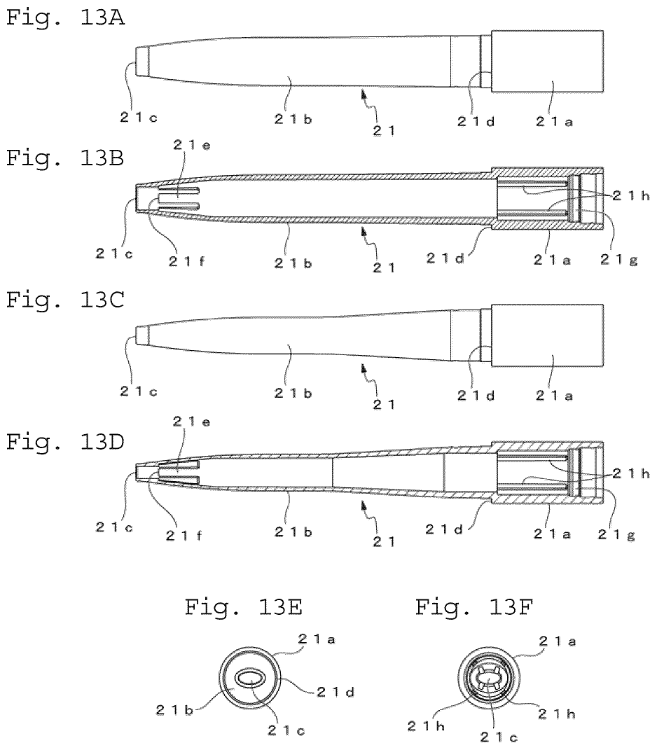

The new component structures employed in the rotary feeding container of the second embodiment will be individually described in the following description, with reference to FIGS. 13A to 16D.

FIGS. 13A to 13F show the single-article configuration of the front barrel 21, and the front barrel 21 is formed with the cylindrical portion 21a at its rear end portion, and the reduced-diameter portion 21b, having an elliptical cross-section perpendicular to the axis, is formed at the front that follows from the cylindrical portion 21a. The opening 21c is formed at the front end portion of the reduced-diameter portion 21b to support the solid core 5 so as to allow it to advance and retract, and a step portion 21d for cap-mounting is formed between the cylindrical portion 21a and the reduced-diameter portion 21b.

Just before the opening 21c of the reduced-diameter portion 21b, a plurality of guide grooves 21e (four in the present embodiment) are formed to receive the respective projections 7b of the holder guide 7 and to support it together with the holder 6 so as to be movable in the axial direction.

Besides, at the front end portion of each of the plurality of guide grooves 21e, a step portion 21f is formed by reducing the inner diameter toward the opening 21c. This step portion 21f functions as a stopper by abutting against the front end portions of the projections 7b formed on the holder guide 7 and thereby preventing forward movement of the holder 6. Accordingly, in the present embodiment, the step portion 21f is referred to as a stopper.

On the inner surface of the rear-end opening portion of the cylindrical portion 21a, an annular locking ring 21g is formed, which serves as a fitting portion when a middle barrel 24, described later, is mounted by press-fitting.

In addition, four ribs 21h are formed along the axial direction and spaced substantially equally along the inner circumference on the inner peripheral surface located at the deep side adjacent to the above-described annular locking ring 21g of the cylindrical portion 21a. These four ribs 21h function to prevent the middle barrel 24 from rotating relative to the front barrel 21 by allowing a plurality of ribs 24a (eight ribs in the present embodiment) formed at equal intervals along the axial direction on the outer periphery of the front end portion of the middle barrel 24, which will be described later, to enter between them in a mutually engaging manner.

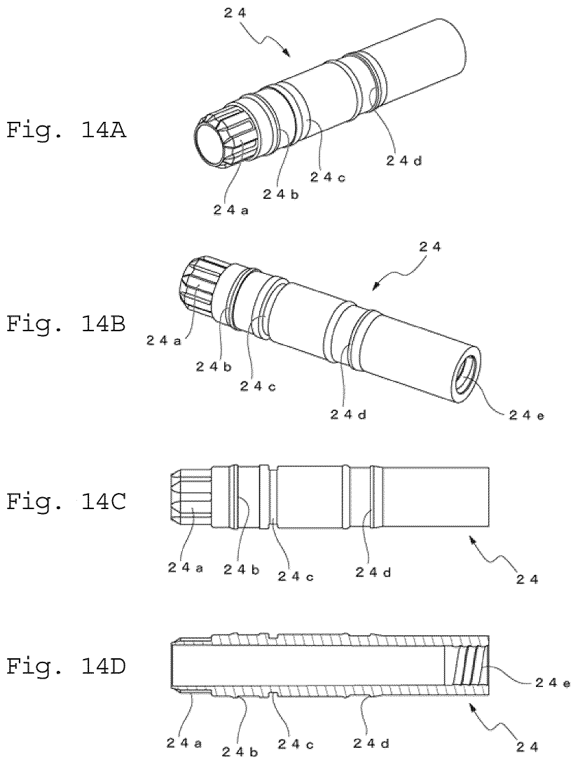

FIGS. 14A to 14D show the single-article configuration of the middle barrel 24, which is mounted by press-fitting onto the rear end portion of the aforementioned front barrel 21.

The middle barrel 24 is formed in a substantially cylindrical shape, and on the outer periphery of its front end portion, a plurality of ribs 24a (eight in the present embodiment) are formed circumferentially at equal intervals, each extending in the axial direction. As described above, when these ribs 24a are inserted into the rear end portion of the front barrel 21, they come into contact with the four ribs 21h inside the front barrel 21. This prevents the middle barrel 24 from rotating relative to the front barrel 21.

Furthermore, on the outer peripheral surface of the middle barrel 24, a first annular rib 24b projecting outward in the circumferential direction, an O-ring mounting groove 24c, and a second annular rib 24d projecting outward in the circumferential direction are sequentially formed toward the rear end portion.

The first annular rib 24b is press-fitted into the locking ring 21g formed inside the cylindrical portion 21a of the front barrel 21, whereby the middle barrel 24 is mounted onto the rear end portion of the front barrel 21 by fitting engagement.

In addition, as shown in FIGS. 12B and 12D, an O-ring 14 is mounted in the O-ring mounting groove 24c, and is configured to slidably contact the inner peripheral surface of the rear barrel 22 in the rotation direction of the shaft.

Furthermore, the second annular rib 24d projecting in the circumferential direction of the middle barrel 24 serves as a retaining member to prevent the rear barrel 22, which is mounted on the rear end portion of the middle barrel 24, from slipping off.

Furthermore, on the inner peripheral surface of the rear end opening of the middle barrel 24, a female thread 24e is formed, and this female thread 24e is configured to be threadedly engaged with a male thread 23d provided on a screw rod 23, which will be described later.

That is, in the present second embodiment, the screw body 11, which was provided as a single-piece component in the first embodiment, is integrated into and provided on the middle barrel 24 side.

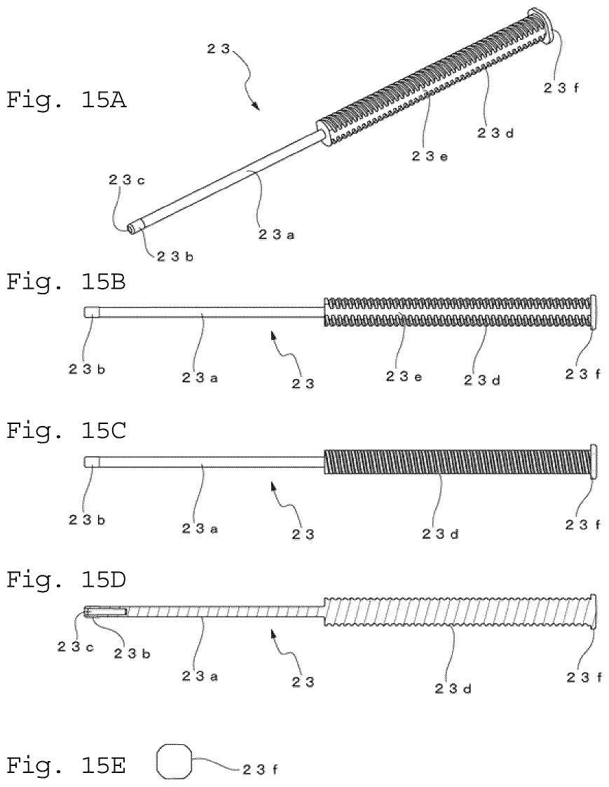

FIGS. 15A to 15E illustrate the single-article configuration of the screw rod 23. The screw rod 23 has a front half portion forming a straight shaft body 23a whose cross section perpendicular to the axis is formed into a true circular shape, and at the front end portion of the shaft body 23a, a short, large-diameter portion 23b having a slightly greater diameter than that of the shaft body 23a is formed. In addition, extending from the front end portion of the shaft body 23a toward the rear portion, including the large-diameter portion 23b, a shaft hole 23c is formed. The shaft hole 23c is provided for imparting elasticity to the large-diameter portion 23b.

In addition, the rear half portion of the screw rod 23 is formed with a larger diameter than the shaft body 23a, and its cross-sectional shape perpendicular to the axis is formed into a substantially true circular shape. Besides, male threads 23d are formed along both the upper and lower surfaces, while flat surface portions 23e extending in the longitudinal direction are formed along both lateral surfaces.

Furthermore, at the rear end portion of the screw rod 23, a brim 23f having a substantially square shape with rounded corners is integrally formed with the screw rod 23.

When the screw rod 23 is inserted into the rear barrel 22, the brim 23f can move axially while engaging with the ribs 22b, which are formed along the axial direction inside the rear barrel 22. As a result, the screw rod 23, including the brim 23f, undergoes rotational movement in the same direction as the rear barrel 22.

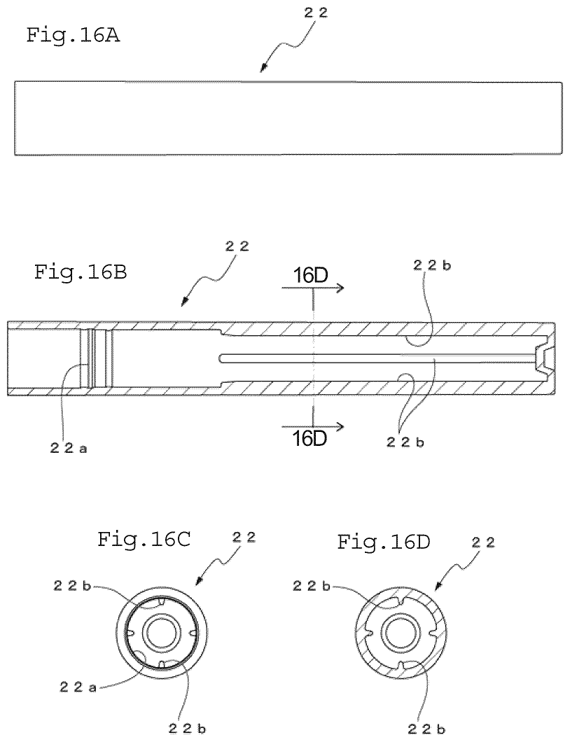

FIGS. 16A to 16D illustrate the single-article configuration of the rear barrel 22, wherein the rear barrel 22 is formed into a cylindrical shape with the rear end portion closed. Besides, an annular rib 22a is formed on the inner peripheral surface located at the slightly deep side of the front end opening. The annular rib 22a functions as a retaining member by climbing over the second annular rib 24d, which projects outward in the circumferential direction of the aforementioned middle barrel 24, thereby preventing detachment from the middle barrel 24. At the same time, the rear barrel 22 is mounted to be rotatable relative to the middle barrel 24, which is fitted and attached to the front barrel 21. As a result, the front barrel 21 and the rear barrel 22 are configured to be able to rotate relative rotation with each other via the middle barrel 24.

In the rear half portion of the rear barrel 22, four ribs 22b erecting toward the axial center from its inner peripheral surface are formed at equal intervals along the inner circumference.

Accordingly, when the aforementioned screw rod 23 is inserted into the rear barrel 22, the corner portions of the brim 23f enter between the ribs 22b. As described above, this configuration allows the screw rod 23 to move axially within the rear barrel 22, while also causing the screw rod 23 to rotate in the same direction as the rear barrel 22, in accompaniment with the rotation of the rear barrel 22.

In this embodiment, the brim 23f is formed in a square shape with rounded corners; however, this configuration depends on the shape of the rear barrel 22 in which the screw rod 23 is accommodated.

In short, the shape of the brim 23f may be appropriately selected in any form other than the illustrated example, provided that it allows axial movement within the rear barrel 22 while functioning such that the screw rod 23 is caused to rotate in the same direction as the rear barrel 22, in accompaniment with the axial rotation of the rear barrel 22.

In the rotary feeding container of the second embodiment provided with the newly described components, the solid core 5 as a stick-shaped member is fed out from the front end opening 21c of the front barrel 21 by rotating the rear barrel 22 clockwise relative to the front barrel 21.

As a result, the screw rod 23 within the rear barrel 22 is caused to rotate clockwise together with the rear barrel 22 by the action of the brim 23f and the like described above. At this time, a male thread 23d of the screw rod 23 is threadedly engaged with a female thread 24e of a middle barrel 24 mounted on the front barrel 21, accordingly, as the screw rod 23 rotates clockwise, the screw rod 23 advances.

Thus, a large-diameter portion 23b formed at the front end portion of the screw rod 23 comes into contact with a piston 8 within the holder 6, and through this piston 8, the solid core 5 advances together with the holder 6 and the holder guide 7.

In contrast, as the solid core 5, the holder 6, and the holder guide 7 advance, the forward movement is restricted when the front end portions of the projections 7b formed on the holder guide 7 come into contact with the stopper 21f formed inside the front barrel 21. FIGS. 12A to 12D show a state in which the front end portions of the projections 7b formed on the holder guide 7 are in abutment with the stopper 21f formed within the front barrel 21.

According to this, the solid core 5 within the holder 6 advances through the interior of the holder 6 and the holder guide 7 via the piston 8 as the screw rod 23 moves forward, and the front end portion of the solid core 5 is fed out from the front-end opening 21c of the front barrel 21.

Therefore, a user can apply makeup, such as to the eyebrows, by using the solid core eyeliner fed out from the rotary feeding container.

After use of the solid core eyeliner, it is necessary to perform an operation to retract the solid core 5 fed out from the front barrel 21 back into the interior of the front barrel 21, and in this retraction operation, the rear barrel 22 is rotated counterclockwise relative to the front barrel 21. As a result, the screw rod 23 within the rear barrel 22 is caused to rotate counterclockwise together with the rear barrel 22 by the action of the brim 23f and the like described above. Then, as the male thread 23d threadedly engaged with the female thread 24e of the middle barrel 24 rotates counterclockwise, the screw rod 23 moves backward.

As the screw rod 23 moves backward, a short large-diameter portion 23b formed at the front end portion of the screw rod 23 abuts with the inner surface of the holder 6 and pulls the holder 6 backward. Accordingly, the solid core 5, the front end of which has been fed out, retracts within the front barrel 21 together with the holder 6 and the holder guide 7, and the front end portion of the solid core 5 is returned into the interior of the front barrel 21.

In this case, the outer diameter of the large-diameter portion 23b is set to be slightly larger than the minor axis of the inner surface of the holder 6, which is formed in an elliptical shape. Accordingly, the large-diameter portion 23b of the screw rod 23 pulls the holder 6 while being in contact, with a slight reactive force, with the inner surface of the holder that faces in the direction of the minor axis of the ellipse.

As described above, forming the shaft hole 23c in the large-diameter portion 23b imparts elasticity, which suppresses variations in the reactive force generated when the large-diameter portion comes into contact with the inner surface of the holder 6.

As shown in FIG. 3, the solid core 5 projecting from the holder 6, which has been retracted into the front barrel 21, can be supported without any gap by the holding surfaces 7b2 on the inner sides of the respective projections 7b of the holder guide 7. Therefore, even if an impact is applied to the container (barrel 3), it is possible to prevent problems such as breakage of the solid core 5 in a state of projecting from the holder 6.

The rotary feeding container according to the present invention described above can be applied without limitation to various uses, including solid cosmetic materials such as eyebrow pencils, eyeliners, and lip liners, writing tools such as colored pencils and pencils, and quasi-pharmaceutical preparations intended for moisturizing areas such as the corners of the mouth and the lip, and it can therefore be used as a rotary feeding container that can hold these materials and make them available as appropriate.

### REFERENCE SIGNS LIST

1 front barrel
1c opening
1e guide groove
2 rear barrel
3 barrel
4 cap
5 stick-shaped member (solid core)
6 holder
6a solid core accommodating portion
7 holder guide
7a base end portion
7b projection
7b1 tapered surface
7b2 solid core holding surfaces
7c axial hole
8 piston (sealing member)
9 screw rod
11 screw body
12 middle barrel
12a screw rod insertion hole
21 front barrel
21c opening
21e guide groove
21f step portion (stopper)
22 rear barrel
22b rib
23 screw rod
23a shaft body
23b large-diameter portion
23c shaft hole
23d male thread
23f brim
24 middle barrel
24e female thread

1. A rotary feeding container, comprising: a barrel formed of a front barrel and a rear barrel configured to be relatively rotatable; a screw rod disposed inside the rear portion of the barrel and performing a forward or backward movement in the barrel by relative rotation of the front barrel and the rear barrel; and a stick-shaped member disposed inside the front portion of the barrel and configured to move axial direction within the front barrel in response to the forward or backward movement of the screw rod, wherein
the stick-shaped member is accommodated in a holder covering the outer circumference of the stick-shaped member, and a holder guide including a plurality of projections extending forward in the axial direction is provided at the tip end portion of the holder, and each is arranged along the circumferential direction, and
a plurality of guide grooves extending axially is formed along the inner circumferential surface of the front shaft, into which each projection of the holder guide enters, allowing each projection to slide axially, and
the front end portion of the stick-shaped member protruding from the holder is supported by the projections provided on the holder guide, during the both states in which the stick-shaped member protrudes from the front barrel in accompaniment with the forward movement of the screw rod and the stick-shaped member retracts and is stored together with the holder in the front barrel in accompaniment with the backward movement of the screw rod.

2. The rotary feeding container according to claim 1,
wherein the rear barrel is rotatably attached to a middle barrel mounted on the front barrel, whereby the front barrel and the rear barrel are configured to be rotatable relative to each other, and a female thread formed in the middle barrel is screwed with a male thread formed on the screw rod, and the screw rod is provided with a brim that is axially movable within the rear barrel and rotates the screw rod in the same direction in response to the rotation of the rear barrel.

3. The rotary feeding container according to claim 2,
wherein a rib protruding toward the axis is formed along the axial direction inside the rear barrel, and the brim formed on the screw rod is movable in the axial direction along the rib, and a part of the brim comes into contact with the rib by the rotation of the rear barrel, whereby the screw rod is configured to be rotated in the same direction in accompaniment with the rotation of the rear barrel.

4. The rotary feeding container according to claim 1,
wherein a large-diameter portion provided with a shaft hole is formed at a front end portion of the screw rod via a shaft body formed in a linear shape, and the large-diameter portion is configured such that the stick-shaped member is projected from the front barrel by advancement of the screw rod and a pulling operation is performed to retract the holder together with the stick-shaped member, in contact with the inside of the holder, by retraction of the screw rod.
